(19) United States
(12) Patent Application Publication
(10) Pub. No.: US 2025/0006960 A1
(43) Pub. Date: Jan. 2, 2025

(54) FIBER MEMBRANE BUNDLE WITHOUT A CORE

(71) Applicant: Pentair, Inc., Minneapolis, MN (US)

(72) Inventors: Eric Lee, Hugo, MN (US); Evan Hoglund, Oak Grove, MN (US); Ryan Delveaux-Han, Minneapolis, MN (US); Lao Xiong, St. Paul, MN (US)

(21) Appl. No.: 18/691,027

(22) PCT Filed: Sep. 12, 2022
(86) PCT No.: PCT/US2022/076316

§ 371 Date: Mar. 11, 2024

Related U.S. Application Data
(60) Provisional application No. 63/261,087, filed on Sep. 10, 2021.

(51) Int. Cl. H01M 8/04119; B01D 63/02

(52) U.S. Cl. CPC H01M 8/04149; B01D 63/02; H01M 8/04141

(57) ABSTRACT

A hollow fiber membrane module without a core is disclosed. The hollow fiber membrane module comprises a plurality of hollow fiber membranes that remain helically wound in an outer region of the hollow fiber membrane bundle absent a core. One or more hollow fiber membrane modules without a core may be positioned in a housing comprising one or more cavities. The housing containing the one or more hollow fiber membrane modules may be provided as a component in a fuel cell humidifier.

### CROSS-REFERENCES TO RELATED APPLICATIONS

This application claims priority under 35 U.S.C. § 119 to U.S. Provisional Patent Application No. 63/261,087 filed on Sep. 10, 2021, the entire contents of which are incorporated herein by reference.

### TECHNICAL FIELD

The present disclosure generally relates to a hollow-fiber membrane bundles for filtration.

### BACKGROUND

Fuel cells are a clean and efficient source of energy. However, it is important to keep the membrane within the fuel cell hydrated to maintain a desired conductivity for efficient operation. Thus, fuel cells may be connected to a humidifier. Existing humidifiers in the market may be a straight-fiber bundle or a helically/concentrically wound bundle. The helically/concentrically wound bundles may contain a core or a center support structure, such as a mandrel, around which the fibers are wound. Traditionally, the core is not removed from the bundle. However, because cores may be made of plastic or metal, they may add unwanted weight to the fiber membrane bundles. Further, cores may be costly. Therefore, there is a need in the market for a fiber membrane bundle without a core.

However, removing a core from the completed bundle may be difficult. Removing the core from a bundle may damage the fiber membrane pattern or cause the shape of the fiber membrane to deform, which may allow air to bypass a tortuous path through the bundle, thereby reducing efficiency. During removal of the core, the fiber membranes may tangle with each other, thereby, causing the fiber membrane bundle to become deformed or damaged. Moreover, it may be difficult to create a helically wound pattern that allows the removal of the mandrel while sustaining a sufficiently high-packing fraction.

Therefore, there is a need in the market for a fiber membrane bundle without a core that maintains a desired fiber membrane pattern even after removal of the core.

### SUMMARY

In one embodiment, a module is provided. The module includes a center region and an outer region surrounding the center region. In a first configuration, the center region includes a core, and in a second configuration, the center region does not include the core. The outer region comprises a plurality of hollow fiber membranes that are helically wound around the center region. In the second configuration, the core comprises a plurality of helically wound or straight fiber membranes.

In some embodiments, the module comprises a first end cap positioned at a first end of the module, and a second end cap positioned at a second end of the module opposite the first end.

In another embodiment, a housing is provided. The housing includes a body comprising one or more cavities, and one or more hollow fiber membrane modules positioned in the one or more cavities. Each of the one or more hollow fiber membrane modules comprises a center region comprising a plurality helically wound or straight fiber membranes, and an outer region comprising a plurality of helically wound fiber membranes wound around the center region.

In some embodiments, each of the one or more cavities are cylindrically shaped.

In some embodiments, each of the one or more cavities are tapered at one end.

In some embodiments, each of the one or more cavities are contoured to follow the approximate shape of the one or more cavities.

In some embodiments, the housing comprises an external portion and an internal portion. The one or more cavities are positioned in the internal portion, and the internal portion encapsulates the one or more hollow fiber membrane modules positioned in the one or more cavities.

In some embodiments, the body comprises a first end, a second end opposite the first end, and a fin positioned between the first end and the second end on the external portion of the body.

In some embodiments, the housing comprises a center opening positioned between the one or more cavities. The one or more hollow fiber membrane modules are positioned in the one or more cavities by placing a temporary constraint around each outer region of the one or more hollow fiber membrane modules, inserting one hollow fiber membrane module of the one or more hollow fiber membrane modules into each of the one or more cavities, and removing the temporary constraint from each outer region of each of the one or more hollow fiber membrane modules.

In some embodiments, the housing is configured to be inserted into a fuel cell humidifier.

In yet another embodiment, a humidifier is provided. The humidifier includes a housing comprising a first end, a second end, and a body positioned between the first end and the second end. The body comprises one or more cavities and each of the one or more cavities comprises a hollow fiber membrane bundle without a core. A first portion is connected to the first end of the housing and a second portion is connected to the second end of the housing. The first portion forms a first seal at the first end of the housing and the second portion forms a second seal at the second end of the housing.

In some embodiments, the first portion comprises a first inlet configured to permit a first fluid to enter the humidifier and flow through each the hollow fiber membrane bundle positioned in the one or more cavities, and the second portion comprises a first outlet configured to permit the first fluid to exit the humidifier.

In some embodiments, the body of the housing comprises a center opening positioned between the one or more cavities.

In some embodiments, prior to the first fluid flowing through each hollow fiber membrane bundle positioned in the one or more cavities, the first fluid flows through the center opening. The center opening is configured to distribute the first fluid through a flow path to each hollow fiber membrane bundle positioned in the one or more cavities.

In some embodiments, the first fluid is an exhaust stream of a fuel cell.

In some embodiments, the first portion comprises a second inlet configured to permit a second fluid to enter the humidifier and flow through each hollow fiber membrane bundle positioned in the one or more cavities. The second portion comprises a second outlet configured to permit the second fluid to exit the humidifier.

In some embodiments, the second fluid is a fuel cell intake air stream.

In some embodiments, the housing comprises a fin positioned between the first end and the second end on an external portion of the housing.

In some embodiments, the first portion surrounds at least a first section of the body of the housing and is connected to the fin. The second portion surrounds at least a second section of the body of the housing and is connected to the fin.

### DESCRIPTION OF THE DRAWINGS

FIG. 1 is a cross-sectional view of a single hollow fiber membrane bundle with a core;

FIG. 2A is a side elevational view of a hollow fiber membrane bundle according to an embodiment;

FIG. 2B is a partial enlarged view of a portion of the hollow fiber membrane bundle of FIG. 2A;

FIG. 2C is an end elevational view of the hollow fiber membrane bundle of FIG. 2A;

FIG. 3A is a side elevational view of a housing according to an embodiment;

FIG. 3B is a top isometric view of the housing of FIG. 3A;

FIG. 3C is a top elevational view of the housing of FIG. 3A;

FIG. 4 is an exploded side isometric view of a humidifier according to an embodiment;

FIG. 5A is a side view of a housing according to another embodiment;

FIG. 5B is a top isometric view of the housing of FIG. 5A;

FIG. 5C is a top elevational view of the housing of FIG. 5A;

FIG. 6A is a side isometric view of a humidifier with transparent portions showing a portion of the housing of FIGS. 5A-5C;

FIG. 6B is a top isometric view of the humidifier of FIG. 6A showing a first side;

FIG. 6C is a bottom isometric view of the humidifier of FIG. 6A;

FIG. 6D is a side elevational view of the humidifier of FIG. 6A showing a second side;

FIG. 6E is an end elevational view of the humidifier of FIG. 6A;

FIG. 7A is a side isometric view of a humidifier showing various fluid flow paths of fluid streams according to an embodiment;

FIG. 7B is a side elevational cross-sectional view of the humidifier of FIG. 6A showing a fluid path of a first fluid; and

FIG. 7C is a side elevational cross-sectional view the humidifier of FIG. 6A showing a fluid path of a second fluid.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

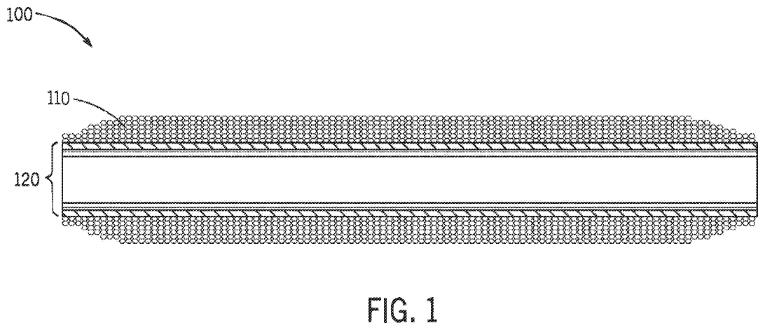

FIG. 1 illustrates a cross-sectional view of a conventional single hollow fiber membrane module 100 with a core. As shown, hollow membrane fibers 110 may be wound around a core 120 which provides a center support structure within the module 100. Such known hollow fiber membrane modules are disclosed in, for example, U.S. Pat. No. 7,998,254 titled “Membrane Module,” which is hereby incorporated by reference. In contrast, the present disclosure provides a hollow fiber membrane module without a core. As discussed in greater detail below, the hollow fiber membrane module may be formed using a core, which is later removed. The present disclosure further provides a humidifier housing that is designed to receive one or more hollow fiber membrane modules without a core.

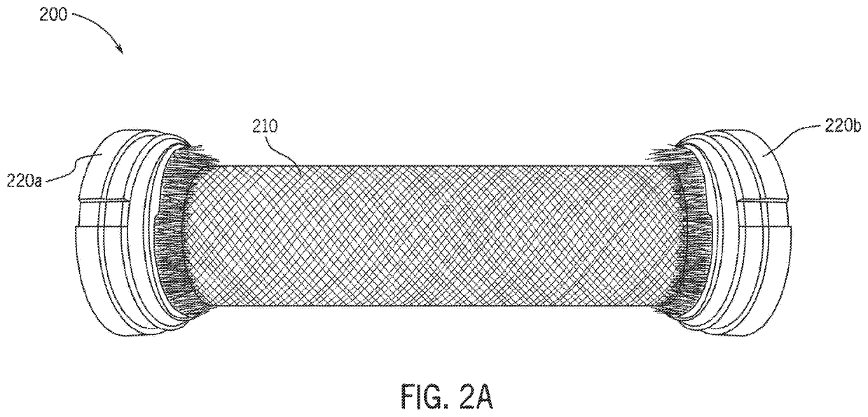

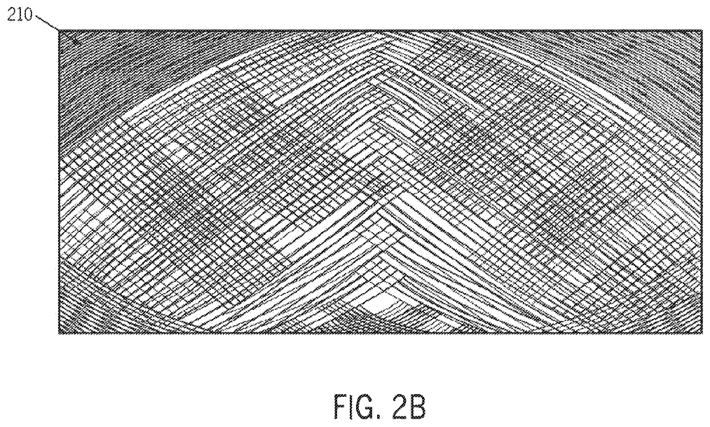

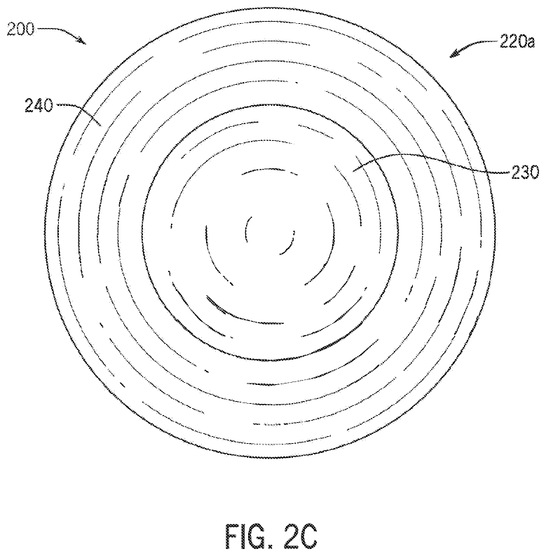

FIGS. 2A-2C illustrate various views of a hollow fiber membrane module 200 without a core according to an embodiment. The hollow fiber membrane module 200 may be formed by helically winding a plurality of hollow fibers 210 around a core (not shown) to form a single unit. The module 200 may have a first end cap 220a positioned at a first end of the module 200, and a second end cap 220b positioned at a second end of the module 200, opposite the first end. FIG. 2B illustrates a close-up view of the hollow fibers 210. As can be seen, the hollow fibers 210 may be wound around a core such that they form a lattice like or woven pattern.

Referring to FIG. 2C, the module 200 may have a center region 230 and an outer region 240. The outer region 240 surrounds the center region 230. During formation of the module 200, a core, for example, a mandrel, may be positioned in the center region 230. The hollow fibers 210 may be wound around the core, thereby forming the outer region 240. The hollow fibers 210 may be helically wound or may be wound around the core using other processes known in the art.

Once the module 200 has been formed, the core may be removed from the center region 230. Once the core is removed, the center region 230 may not have a hollow space at the center of the module 200. Instead, the center region 230 may be filled with helically wound or straight hollow fiber membranes 210. As such, even without a core, the module 200 may retain its helical pattern in the outer region and helical or straight pattern in the center region 230 even after the core is removed. By removing the core, the overall weight, cost, size, and complexity of the module 200 may be reduced. Moreover, the efficiency of the module 200 may be higher than conventional modules with a core because the fluids flowing through the module 200 may be forced to pass through the fiber membrane instead of bypassing the fiber membrane and filling the hollow/void space in the center of the module. Thus, the module 200 may optimize the efficiency of water transfer by promoting uniform flow to every, or most surfaces of the hollow fiber membrane module.

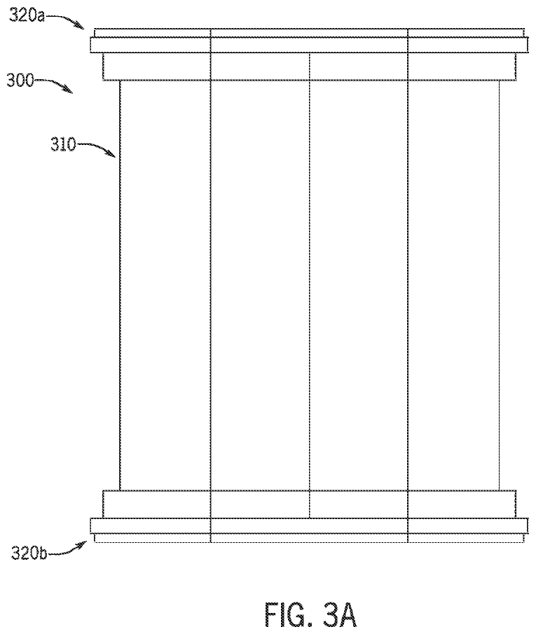

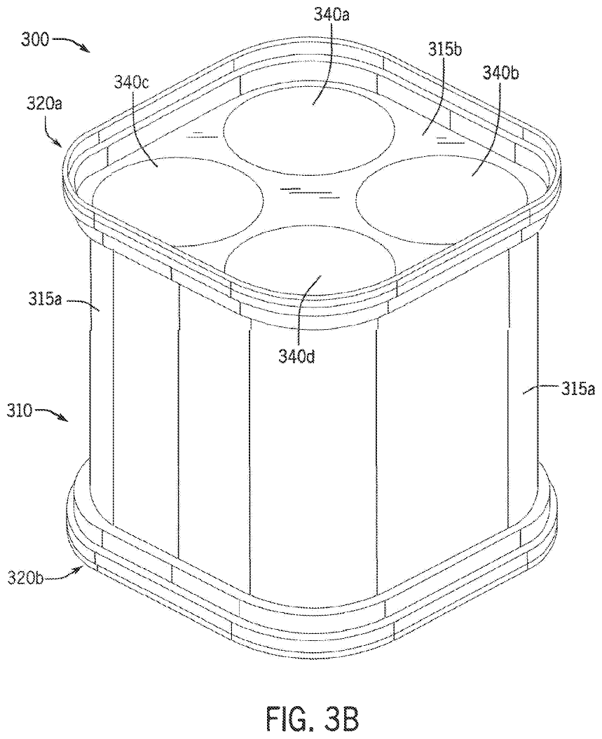

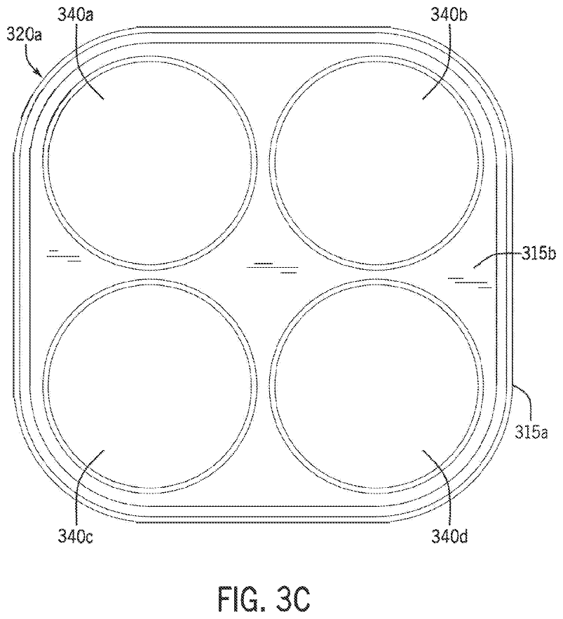

Turning to FIGS. 3A-3C, various views of a housing 300 are shown. The housing 300 may hold one or more hollow fiber membrane modules without a core, such as the module 200 of FIGS. 2A-2C.

The housing 300 includes a body 310, a first end 320a, and a second end 320b. The body 310 has an external portion 315a and an internal portion 315b. As shown, the housing 300 may have a cross-section that is substantially square or rectangular in shape. The external portion 315a may have rounded corners or may have angular corners. However, it is to be understood that the housing 300 can be provided in the form of any other shapes designed to hold the hollow fiber membrane modules disclosed herein.

The internal portion 315b of the housing 300 may have one or more cavities. As shown in FIGS. 3B-3C, the housing has four cavities 340a-340d. The cavities may be approximately cylindrically shaped or may be tapered. The cavities 340a-340d may be about 1 inch to about 6 inches in diameter. The cavities 340a-340d may each hold a fiber membrane module such as the module 200 of FIGS. 2A-2C. The first and second ends 320a, 320b, may each be open. As such, the modules may be inserted into the cavities 340a-340d at either end of the housing 300.

Referring back to FIG. 2A-2C, to insert a hollow fiber membrane module without a core into the housing 300, the outer region 240 of the module 200 is temporarily constrained. While constrained, the module 200 may be inserted into one of the cavities 340a-340d of the housing 300. After the module 200 is placed in one of the cavities 340a-340d the temporary constraint is removed. After the constraint is removed, the hollow fibers of the module 200 may expand due to residual tension from the wrapping process to fill the respective cavity 340a-340d and center region 230 of the of the module 200. By removing the core, the overall package size and weight of the housing 300 may be reduced. Furthermore, durability of the module 200 may be improved because modules with a core may be more likely to fail when exposed to high temperature and humidity due to expansion/contraction of the membrane bundle.

Turning back to FIGS. 3A-3C, the internal portion 315b may encapsulate and/or isolate the modules in the cavities 340a-340d (i.e., separate each of the modules from each other). The internal portion 315a may be provided in the form of a thermoset polymer. By encapsulating multiple modules in a single housing 300, the need for separate seals for each of the cavities 340a-340d may be reduced or eliminated. As such, the complexity and size of the housing may be reduced, and there may be a lower risk of failure because there are less components. As discussed below, the housing 300 may be provided as part of a humidifier.

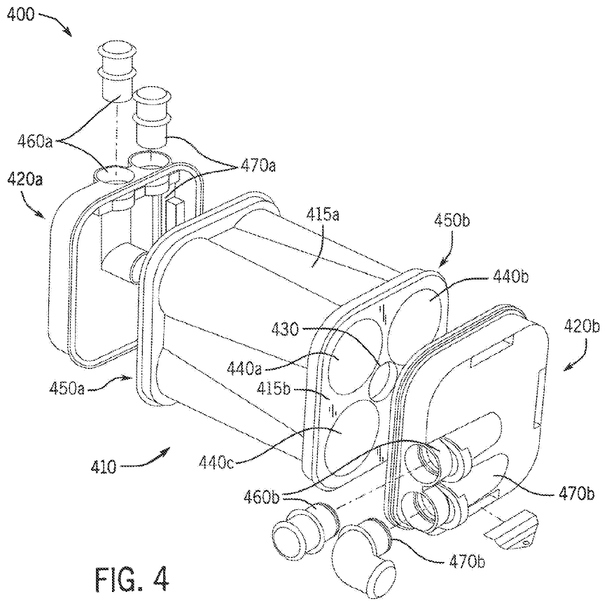

FIG. 4 is an exploded side isometric view of a humidifier 400 according to an embodiment. As shown, the humidifier 400 comprises a housing 410 positioned between a first end cap 420a and a second end cap 420b. The housing 410 may be the housing 300 of FIGS. 3A-3C. However, as shown, the housing 410 may have an alternative structure to that shown in FIGS. 3A-3C. An external portion 415a of the housing 410 may have a molded or contoured shape (i.e., the external portion 415a is not completely rectangular in shape). Further, an internal portion 415b of the housing 410 may have a center opening 430 positioned between one or more cavities 440a-440d (cavity 430d is not shown). Each of the cavities 440a-440d may contain a hollow fiber membrane module, such as the module 200 of FIGS. 2A-2C. The center opening 430 may permit a fluid, such as wet air to pass through one or more modules contained in the housing 410.

The first and second end caps 420a, 420b may be identical. The first end cap 420a may be attached to a first end 450a of the housing 410. Similarly, the second end cap 420b may be attached to a second end 450b of the housing 410. Each of the first and second end caps 420a, 420b may contain a first opening 460a, 460b, and a second opening 470a, 470b, respectively. Fluids may flow through the humidifier 400 either from the first end 450a of the housing to the second end 450b of the housing 410, or from the second end 450b to the first end 450a. As such, the first and second openings 460a, 470b of the first end cap 420a may act as an inlet or an outlet, and the first and second openings 460b, 470b of the second end cap 420b may also act as an inlet or an outlet depending on the direction of fluid flow through the humidifier 400.

As shown, the first opening 460a of the first end cap 420a, and the first opening 460b of the second end cap 420b are positioned approximately in the center of the first and second end caps 420a, 420b respectively (i.e., the first openings 460a, 460b align with the center opening 430 of the housing 410). As such, the first openings 460a, 460b permit a first fluid, such as wet air to enter the humidifier 400, pass through the center opening 430, and exit the humidifier 400. The second openings 470a, 470b are positioned adjacent to the first openings 460a, 460b, respectively, and permit a second fluid, such as dry air, to enter the humidifier 400, pass through one or more hollow fiber membrane modules positioned in the cavities 440a-440d, and exit the humidifier 400.

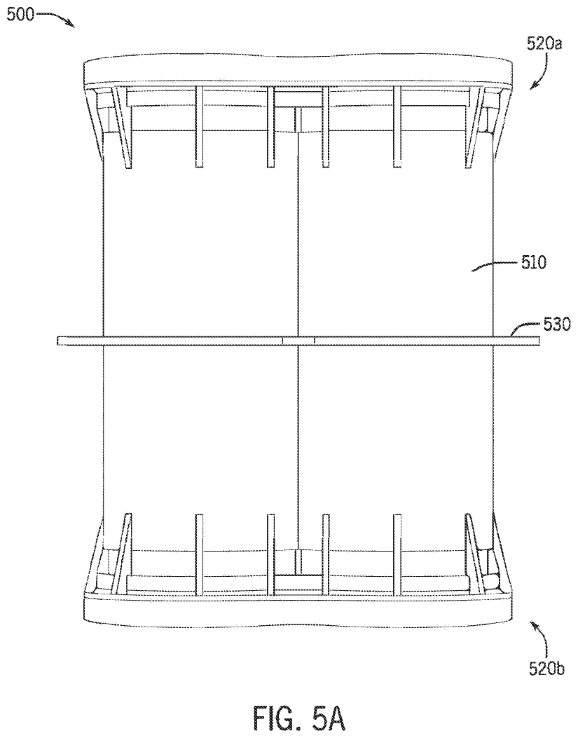

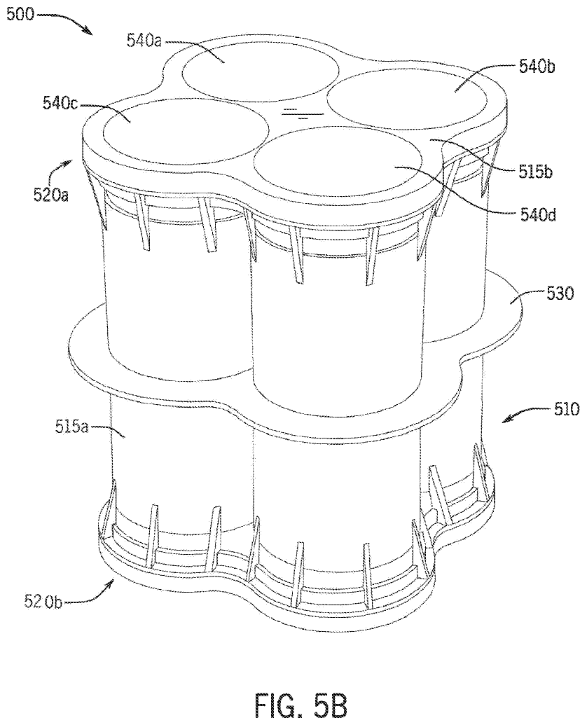

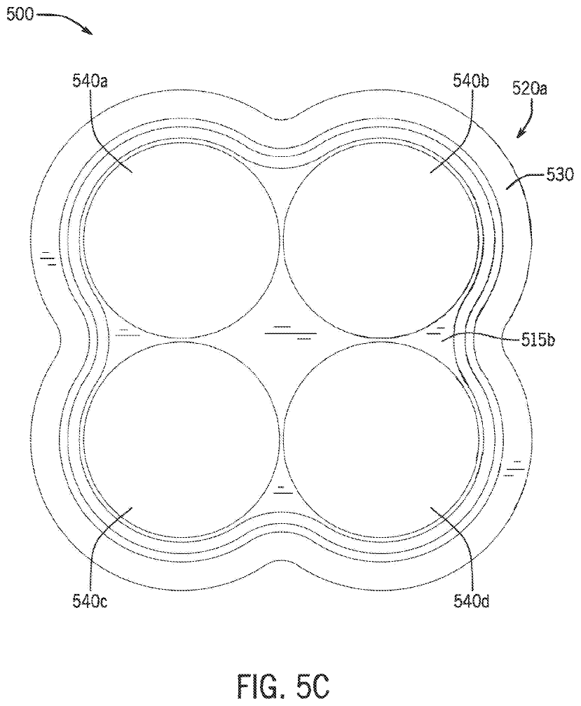

FIGS. 5A-5C illustrate a housing 500 according to an embodiment. The housing 500 is similar to the housing 300 of FIGS. 3A-3C. However, here an external portion 515a of a body 510 of the housing 500 is shaped differently. Further, as discussed below, the housing 500 may be surrounded by an external housing of a humidifier. As shown, the external portion 515a is contoured to generally follow the shape of one or more cavities 540a-540d in an internal portion 515b of the body 510. The body 510 further includes a lip 530, which is positioned on the external portion 515a of the body. The lip 530 may be positioned approximately an equal distance from a first end 520a and a second end 520b of the housing 500 (e.g., the lip 530 may be positioned in the middle of the housing 500).

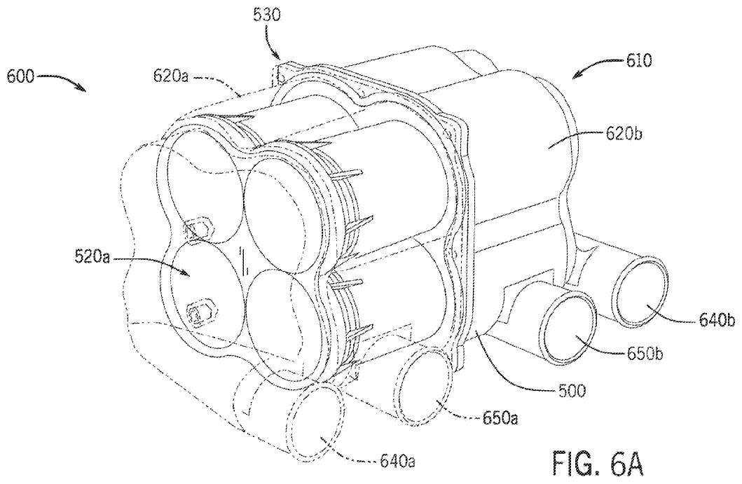

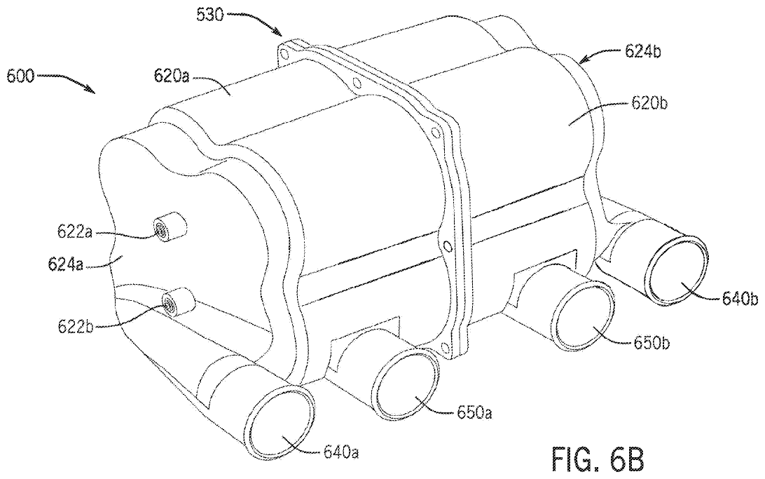

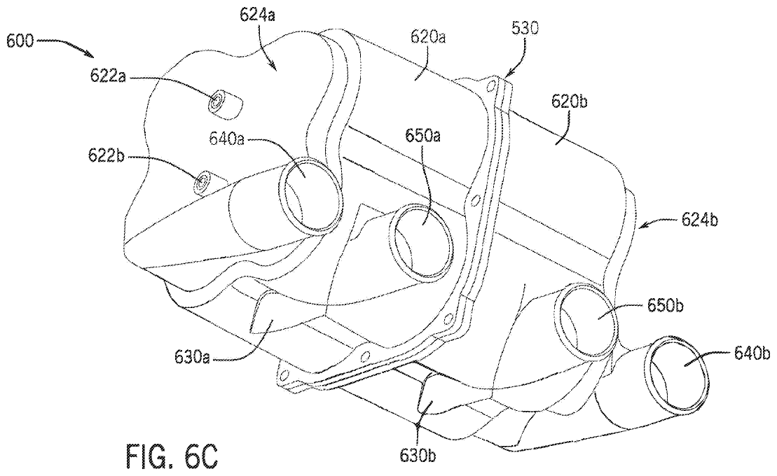

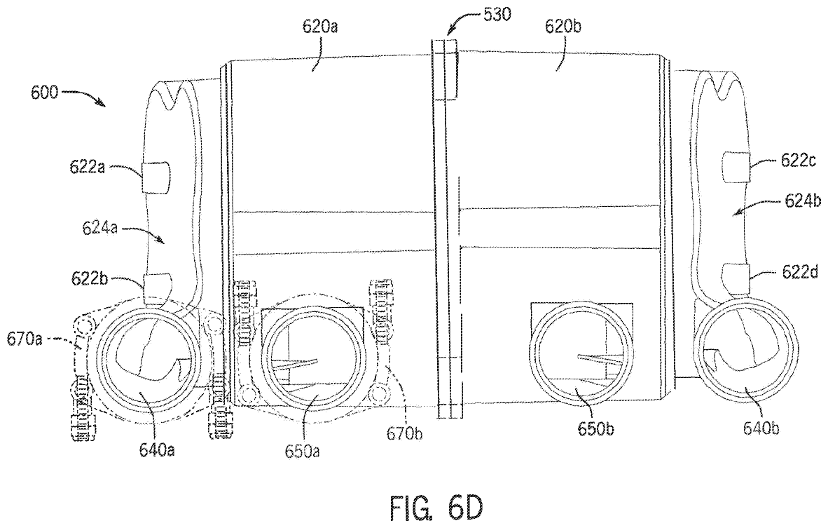

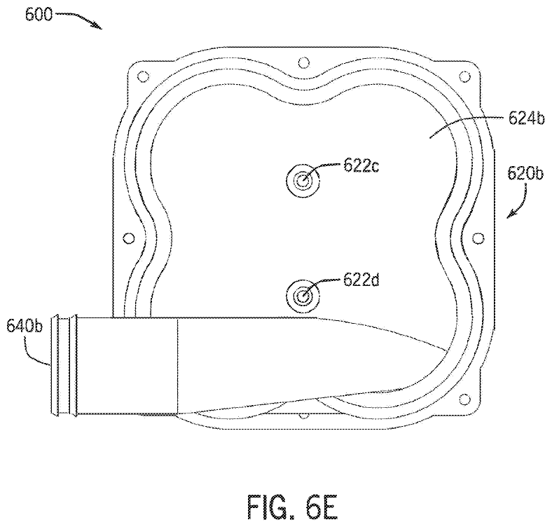

FIGS. 6A-6E illustrate various views of a humidifier 600 according to an embodiment. The humidifier 600 may have an external housing 610 that contains the housing 500 of FIGS. 5A-5C. The external housing 610 may have a first portion 620a and a second portion 620b.

FIG. 6A illustrates the humidifier 600 where the first portion 620a is shown as transparent in order to show a portion of the housing 500 of FIGS. 5A-5C. As shown, the first portion 620a covers the first end 520a of the housing 500 and is connected to the lip 530. Similarly, the second portion 620b covers the second end 520b of the housing 500 and is connected to the lip 530.

The first portion 620a may be connected to the first end 520a via threaded insert mountings 622a and 622b positioned on a first end 624a of the first portion 620a. The second portion 620b may be connected to the second end 520b via threaded insert mountings 622c and 622d positioned on a second end 624b of the second portion 620b. As such, the external housing 610 may completely enclose the housing 500.

The first portion 620a and the second portion 620b of the external housing 610 may be identical. Each of the first and second portions 620a, 620b may contain a first opening 640a, 650b, respectively. Fluids may flow into the humidifier 600 either from the first portion 620a, through the housing 500, and to the second portion 620b, or from the second portion 620b, through the housing 500, and to the first portion 620a. As such, the opening 640a may act as an inlet or an outlet, and the opening 640b may also act as an inlet or an outlet depending on the direction of flow through the humidifier 600. Similarly, each of the first and second end portions 620a, 620b may contain a second opening 650a, 650b, respectively.

The first openings 640a, 640b may be positioned on the first end 624a of the first portion 620a, or second end 624b of the second portion 620b, respectively. As shown, the first openings 640a, 640b are not centered in the first and second ends 624a, 624b. However, it is to be understood that the first openings 640a, 640b may be centered in the first and second ends 624a, 624b. As shown, the second openings 650a, 650b are positioned on a side of the first and second portions 620a, 620b, respectively. As shown, the second openings 650a, 650b may be positioned such that the openings are facing the same direction as the first openings 640a, 640b. However, it is to be understood that the first openings 640a, 640b and the second openings 650a, 650b may not face the same direction.

Further, because the first portion 620a and the second portion 620b may be substantially identical, the first portion 620a and the second portion 620b may be rotated and attached to the lip 530 of the housing 500 in a variety of configurations. For example, as shown, the first and second portions 620a, 620b may be attached such that all of the openings 640a, 640b, 650a, and 650b are facing the same direction. Alternatively, the first portion 620a and/or the second portion 620b may be rotated (i.e., the first opening 640a and the second opening 650a of the first portion 620a are positioned in a first direction, and the first opening 640b and the second opening 650b of the second portion 620b are positioned in a second, different direction). This is possible because both the housing 500 enclosed in the external housing 610, and the first and second portions 620a, 620b of the external housing 610 are symmetrical.

By being able to modify how the first and second portions 620a, 620b are attached to the lip 530, the external housing 610 of the humidifier 600 may be adjusted to accommodate various layouts. Further, as illustrated in FIG. 6D, the first openings 640a, 640d and the second openings 650a, 650b are positioned adjacent to each other respectively such that there is enough spacing for band clamps to be placed around each opening. For example, as shown, a first band clamp 660a may be placed around the first opening 640a and a second band clamp 660b may be placed around the second opening 650a. The first and second band clamps 660a, 660b may be used to couple piping to the first openings 640a, 640b and the second openings 650a, 650b.

The external housing 610 may further include one or more channels for draining water. As shown in FIG. 6C, the first portion 620a has a first channel 630a and the second portion 620b has a second channel 630b. Although the humidifier 600 is shown as having two channels 630a, 630b, the humidifier 600 may include more or fewer channels depending on the embodiment. Additionally, channels may be placed on one or more sides of the first and second portions 620a, 620b.

It is to be understood that although the humidifier 600 is shown as having the housing 500 of FIGS. 5A-5C, the humidifier 600 may contain housing having alternative structures, such as the housing 300 of FIGS. 3A-3C, and/or the housing 410 of FIG. 4.

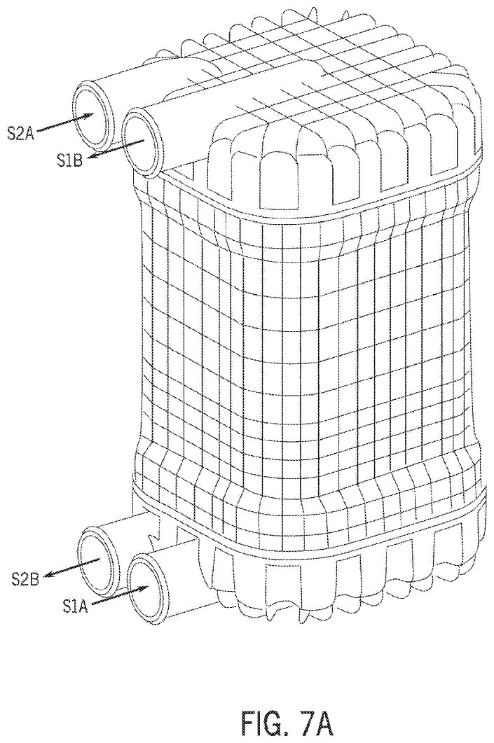

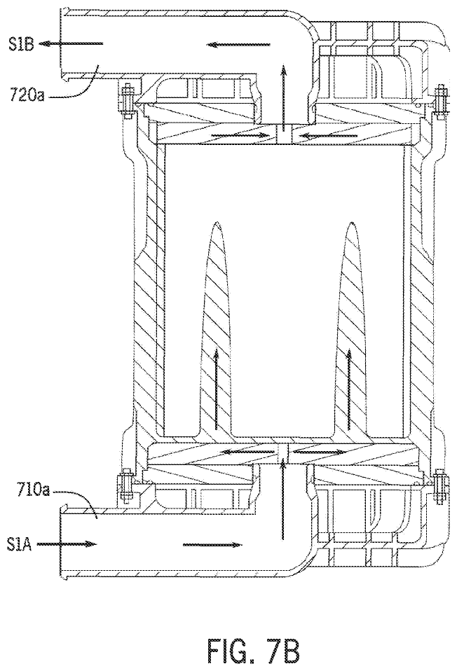

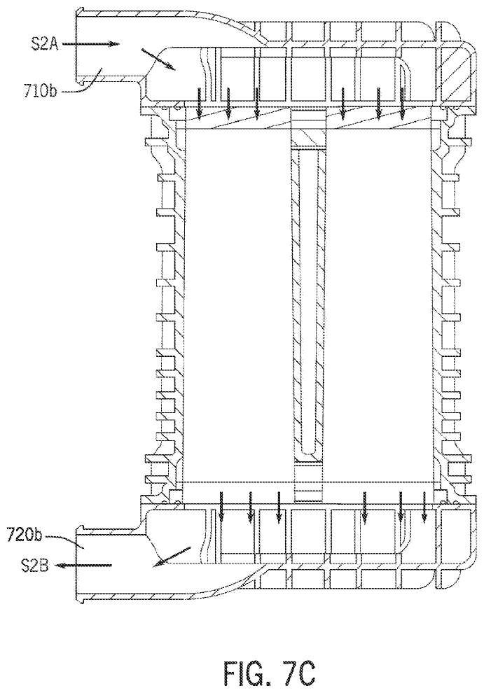

Turning to FIGS. 7A-7C, the flow paths of a first and second fluid flowing through a humidifier 700 are shown. The humidifier 700 may be the humidifier 400 of FIG. 4, and/or humidifier 600 of FIGS. 6A-6E.

FIG. 7B is a cross-sectional view of the humidifier 700. As shown, a flow path of a first fluid starts at S1A, where the first fluid enters the humidifier 700 at a first inlet 710a. The first inlet 710a may be the first opening 460a of the first end cap 420a or the first opening 460b of the second end cap 420b of FIG. 4, or may be the first opening 640a of the first portion 620a or the first opening 640b of the second portion 620b of FIGS. 6A-6E. The first fluid flow path may be split among one or more hollow fiber membrane modules housed in the humidifier 700. As shown, the first fluid flows through the center of at least two modules and then converges to form a single flow path SIB that exits the humidifier 700 at a first outlet 720a. The second opening 720a may be the first opening 460a of the first end cap 420a or the first opening 460b of the second end cap 420b of FIG. 4, or may be the first opening 640a of the first portion 620a or the first opening 640b of the second portion 620b of FIGS. 6A-6E.

FIG. 7C is a cross-sectional view of the humidifier 700, showing a second fluid flow path. As shown, a flow path of the second fluid starts at S2A, where the second fluid enters the humidifier 700 at a second inlet 710b. The second inlet 710b may be the second opening 470a of the first end cap 420a or the second opening 470b of the second end cap 420b of FIG. 4, or may be the second opening 650a of the first portion 620a or the second opening 650b of the second portion 620b of FIGS. 6A-6E. The second inlet 710b is positioned adjacent to the first outlet 720a of FIG. 7B. The second fluid flows through the fiber membrane of one or more modules housed in the humidifier 700. As shown, the second fluid flows through two modules then converges into a single flow path S2B that exits the humidifier 700 at a second outlet 720b. The second outlet 720b may be the second opening 470a of the first end cap 420a or the second opening 470b of the second end cap 420b of FIG. 4, or may be the second opening 650a of the first portion 620a or the second opening 650b of the second portion 620b of FIGS. 6A-6E.

The first fluid may be a wet fluid (i.e. a fluid having a relatively high water content), such as the exhaust from a fuel cell. The second fluid may be a dry fluid (i.e., a fluid having a water content lower than the first fluid), such as the intake air for a fuel cell. As mentioned above, if intake air is too dry, the membrane in the fuel cell may become dry and negatively impact the performance of the fuel cell. However, because water is a byproduct of a fuel cell, the fuel cell exhaust may be used to hydrate the intake air prior to the intake air entering the fuel cell. As such, first inlet 710a may be connected to and downstream of an exhaust line of a fuel cell, and the second outlet 720b may be connected to and upstream of an air intake line of the fuel cell.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

1. A hollow fiber membrane module, comprising:
a center region; and
an outer region surrounding the center region, the outer region comprising a plurality of hollow fiber membranes that are helically wound around the center region, the center region being coreless.

2. The module of claim 1 further including a first end cap positioned at a first end of the module and a second end cap positioned at a second end of the module opposite the first end.

3. A housing, comprising;
a body comprising one or more cavities; and
one or more hollow fiber membrane modules positioned in the one or more cavities, each of the one or more hollow fiber membrane modules comprises:
a center region comprising a plurality helically wound or straight fiber membranes; and
an outer region comprising a plurality of helically wound fiber membranes wound around the center region.

4. The housing of claim 3, wherein each of the one or more cavities are cylindrically shaped.

5. The housing of claim 3, wherein each of the one or more cavities are tapered at one end.

6. The housing of claim 3, wherein each of the one or more cavities are contoured to follow the approximate shape of the one or more hollow fiber membrane modules.

7. The housing of claim 3, wherein the housing comprises:
an external portion; and
an internal portion, the one or more cavities being positioned in the internal portion, and wherein the internal portion encapsulates the one or more hollow fiber membrane modules positioned in the one or more cavities.

8. The housing of claim 7, wherein the body comprises:
a first end;
a second end opposite the first end; and
a fin positioned between the first end and the second end on the external portion of the body.

9. The housing of claim 3, wherein the housing comprises a center opening positioned between the one or more cavities.

10. The housing of claim 3, wherein the one or more hollow fiber membrane modules are positioned in the one or more cavities by:
placing a temporary constraint around each outer region of the one or more hollow fiber membrane modules;
inserting one hollow fiber membrane module of the one or more hollow fiber membrane modules into each of the one or more cavities; and
removing the temporary constraint from each outer region of each of the one or more hollow fiber membrane modules.

11. The housing of claim 3, wherein the housing is configured to be inserted into a fuel cell humidifier.

12. A fuel cell humidifier, comprising:
a housing comprising:
a first end and a second end opposite the first end;
a body positioned between the first end and the second end and defined by one or more cavities, each of the one or more cavities including a hollow fiber membrane bundle without a core;
a first portion connected to the first end of the housing;
a second portion connected to the second end of the housing;
wherein the first portion forms a first seal at the first end of the housing; and
wherein the second portion forms a second seal at the second end of the housing.

13. The humidifier of claim 12, wherein:
the first portion comprises a first inlet configured to permit a first fluid to enter the humidifier and flow through each the hollow fiber membrane bundle positioned in the one or more cavities; and
the second portion comprises a first outlet configured to permit the first fluid to exit the humidifier.

14. The humidifier of claim 13, wherein the body of the housing comprises a center opening positioned between the one or more cavities.

15. The humidifier of claim 14, wherein prior to the first fluid flowing through each hollow fiber membrane bundle positioned in the one or more cavities, the first fluid flows through the center opening; and
wherein the center opening is configured to distribute a flow path of the first fluid to each hollow fiber membrane bundle positioned in the one or more cavities.

16. The humidifier of claim 13, wherein the first fluid is an exhaust stream of a fuel cell.

17. The humidifier of claim 13, wherein:
the first portion comprises a second inlet configured to permit a second fluid to enter the humidifier and flow through each hollow fiber membrane bundle positioned in the one or more cavities; and
the second portion comprises a second outlet configured to permit the second fluid to exit the humidifier.

18. The humidifier of claim 17, wherein the second fluid is a fuel cell intake air stream.

19. The humidifier of claim 13, wherein the housing comprises a fin positioned between the first end and the second end on an external portion of the housing.

20. The humidifier of claim 19, wherein the first portion surrounds at least a first section of the body of the housing and is connected to the fin; and
wherein the second portion surrounds at least a second section of the body of the housing and is connected to the fin.
